(19) United States
(12) Patent Application Publication
(10) Pub. No.: US 2012/0020126 A1
(43) Pub. Date: Jan. 26, 2012

(54) CONTROL DEVICE OF TRANSFORMER COUPLING TYPE BOOSTER

(75) Inventor: Atsushi Moki, Kanagawa (JP)

(73) Assignee: KOMATSU LTD., Tokyo (JP)

(21) Appl. No.: 13/262,273

(22) PCT Filed: Apr. 1, 2010
(86) PCT No.: PCT/JP2010/056002

§ 371 Date: Sep. 30, 2011

(30) Foreign Application Priority Data
Apr. 3, 2009 (JP) 2009-091114

(51) Int. Cl. H02M 7/5387

(52) U.S. Cl. 363/71

(57) ABSTRACT

A control device of a transformer coupling type booster performs switching control of applying ON/OFF switching signals to the respective switching elements and alternately repeating, at a predetermined cycle, a voltage positive polarity period where an inter-terminal voltage of the low-voltage side winding and an inter-terminal voltage of a high-voltage side winding have a positive polarity, and a voltage negative polarity period where those inter-terminal voltages have a negative polarity. Upon performing the foregoing control, added is control of providing a zero voltage period between the voltage positive polarity period and the voltage negative polarity period of the inter-terminal voltage of the low-voltage side winding and the inter-terminal voltage of the high-voltage side winding in order to lower a transformer effective current value. In this case, the zero voltage period is formed between the voltage positive polarity period and the voltage negative polarity period of the inter-terminal voltage of the low-voltage side winding and the inter-terminal voltage of the high-voltage side winding by providing a phase difference between the respective switching signals to be applied to the respective switching elements of the low-voltage side inverter and providing a phase difference between the respective switching signals to be applied to the respective switching elements of the high-voltage side inverter.

### TECHNICAL FIELD

The present invention relates to a control device of a transformer coupling type booster in which a low-voltage side inverter and a high-voltage side inverter are coupled via a transformer, and which boosts an input voltage between input terminals of an electrical storage device and applies this as an output voltage between output terminals.

### BACKGROUND ART

In recent years, the development of hybrid vehicles is being conducted as with general automobiles even in the field of construction machinery.

This type of hybrid construction machine comprises an engine, a generator motor, an electrical storage device, and an operating machine motor for driving an operating machine. Here, the electrical storage device is a storage cell (secondary cell) that can freely perform charge and discharge, and is configured from a capacitor, a battery or the like. Note that, in the ensuing explanation, a capacitor is explained as the representative example of the electrical storage device. A capacitor as the electrical storage device accumulates power that is generated based on the generative operation of a generator motor or an operating machine motor. This is referred to as regeneration. Moreover, a capacitor supplies its accumulated power to the generator motor via a driver, or supplies such power to the operating machine motor. This is referred to as powering.

The power load or the operating machine motor in a hybrid construction machine consumes great power in comparison to the engine shaft output, unlike the power load in a standard automobile. Thus, as the electrical storage device that is mounted on a hybrid construction machine, a capacitor capable of charging and discharging bulk power in a short period of time is used.

Nevertheless, a capacitor with a great capacity that is capable of charging and discharging bulk power takes up a lot of space, and occupies a considerable area upon vehicle installation. Thus, in order to downsize the capacitor as much as possible, there are cases where the inter-terminal voltage of the capacitor is set to, for example, around 300 V, and a booster is used to boost this to, for example, around 600 V.

Among these boosters, there is a type referred to as a transformer coupling type booster.

With a transformer coupling type booster, a low-voltage side inverter and a high-voltage side inverter are coupled via a transformer, and an input voltage between input terminals of an electrical storage device is boosted and applied as an output voltage between output terminals. An example of a transformer coupling type booster is described in the following Patent Document.

### Patent Document 1: WO2007/60998

### DISCLOSURE OF THE INVENTION

### Problems to be Solved by the Invention

Based on the principle of operation, a transformer coupling type booster is subject to the generation of a reactive current. Note that a reactive current is a current that is not used effectively as a task, and corresponds to reactive power. The increase of reactive current leads to the increase of transformer effective current and the increase of current flowing into the switching element, and consequently leads to the increase of energy loss since the current is lost as heat.

The reactive current becomes greater as the voltage conditions are set to a point away from an equilibrium point. An equilibrium point is a point that the transformer coupling type booster is operated under the voltage conditions where the ratio of the low-voltage side winding inter-terminal voltage maximum value V1 and the high-voltage side winding inter-terminal voltage maximum value V2 of the transformer coupling type booster (hereinafter referred to as the “transformer voltage ratio”: V2/V1) becomes equivalent to the ratio of the low-voltage side winding turns N1 and the high-voltage side winding turns N2 of the transformer (hereinafter referred to as the “transformer turns ratio”: N2/N1).

The influence that the reactive current on energy loss is notable during a low load when the output voltage is small. A reactive current flows even during a no load (output power 0 kW). When reactive current is generated, the transformer and the switching element generate heat, the energy that is accumulated in the capacitor as input voltage is not effectively used as a task, and is wastefully consumed within the circuit of the transformer coupling type booster.

The present invention was devised in view of the foregoing circumstances, and its object is to resolve the foregoing problems by inhibiting the energy loss of the transformer coupling type booster and improving the energy efficiency.

### Means to Solve the Problems

The first invention is a control device of a transformer coupling type booster in which a low-voltage side inverter and a high-voltage side inverter are coupled via a transformer, and which boosts an input voltage between input terminals of an electrical storage device and applies this as an output voltage between output terminals,

wherein the low-voltage side inverter is configured by including:

four switching elements which are bridge-connected to both terminals of a low-voltage side winding of the transformer; and

a diode connected parallel to each of the switching elements so that its polarity is inverted from that of the switching element,

wherein the high-voltage side inverter is configured by including:

four switching elements which are bridge-connected to both terminals of a high-voltage side winding of the transformer; and

a diode connected parallel to each of the switching elements so that its polarity is inverted from that of the switching element,

both the inverters are connected in series so that a positive electrode of the low-voltage side inverter and a negative electrode of the high-voltage side inverter have an additive polarity,

the control device has control means for performing switching control of applying ON/OFF switching signals to the respective switching elements and alternately repeating, at a predetermined cycle, a voltage positive polarity period where an inter-terminal voltage of the low-voltage side winding and an inter-terminal voltage of the high-voltage side winding have a positive polarity, and a voltage negative polarity period where those inter-terminal voltages have a negative polarity, and

the control means adds, upon performing the switching control, control of providing a zero voltage period between the voltage positive polarity period and the voltage negative polarity period of the inter-terminal voltage of the low-voltage side winding or/and the inter-terminal voltage of the high-voltage side winding.

The second invention is the control device of a transformer coupling type booster according to the first invention,

wherein the control means forms the zero voltage period between the voltage positive polarity period and the voltage negative polarity period of the inter-terminal voltage of the low-voltage side winding or/and the inter-terminal voltage of the high-voltage side winding by providing a phase difference between the respective switching signals to be applied to the respective switching elements configuring the low-voltage side inverter or/and providing a phase difference between the respective switching signals to be applied to the respective switching elements configuring the high-voltage side inverter.

The third invention is the control device of a transformer coupling type booster according to the first invention,

wherein the control means adjusts, as parameters, a phase difference between the respective switching signals to be applied to the respective switching elements configuring the low-voltage side inverter and the respective switching signals to be applied to the respective switching elements configuring the high-voltage side inverter, a period where the voltage becomes zero between the terminals of the low-voltage side winding, and a period where the voltage becomes zero between the terminals of the high-voltage side winding.

The fourth invention is the control device of a transformer coupling type booster according to the third invention,

wherein optimal parameter values are set in advance in correspondence with operating conditions including the input voltage between the input terminals of the electrical storage device and the output voltage of the transformer coupling type booster and a transformer turns ratio.

According to the first invention, since a zero voltage period is provided between the voltage positive polarity period and the voltage negative polarity period of the inter-terminal voltage of the low-voltage side winding or/and the inter-terminal voltage of the high-voltage side winding, the peak current of the transformer will decrease, and the transformer effective current will decrease. The reactive current can thereby be reduced.

In the first invention, the expression “adds control of providing a zero voltage period” means both of the following cases; namely:
a) constantly providing a zero voltage period between the voltage positive polarity period and the voltage negative polarity period regardless of the operating conditions (for instance, the input voltage value); and
b) alternately repeating the voltage positive polarity period and the voltage negative polarity period without providing a zero voltage period as with the conventional method depending on the operating conditions, but providing a zero voltage period between the voltage positive polarity period and the voltage negative polarity period depending on the operating conditions.

In the third invention, the expression “to reduce the transformer effective current value by adjusting as parameters” means that, since the values of the “phase difference between the respective switching signals to be applied to the respective switching elements configuring the low-voltage side inverter and the respective switching signals to be applied to the respective switching elements configuring the high-voltage side inverter,” “the period where the voltage becomes zero between the terminals of the low-voltage side winding,” and “the period where the voltage becomes zero between the terminals of the high-voltage side winding” which are optimal for reducing the transformer effective current according to the operating conditions (for instance, the input voltage value) are different, these variables are adjusted as parameters.

In the fourth invention, the expression “optimal parameter values are set in advance” means that, since the values of the “phase difference between the respective switching signals to be applied to the respective switching elements configuring the low-voltage side inverter and the respective switching signals to be applied to the respective switching elements configuring the high-voltage side inverter,” “the period where the voltage becomes zero between the terminals of the low-voltage side winding,” and “the period where the voltage becomes zero between the terminals of the high-voltage side winding” which are optimal for reducing the transformer effective current according to the operating conditions including the input voltage between input terminals of the electrical storage device and the output voltage of the transformer coupling type booster and the transformer turns ratio are different, the optimal values of these parameter are set in advance, and adjusted by reading the setting values thereof during the control.

### Effects of the Invention

As described above, according to the present invention, since the reactive current can be reduced relative to the same output power, it is possible to inhibit the energy loss of the transformer coupling type booster and improve the energy efficiency.

### BRIEF DESCRIPTION OF THE DRAWINGS

FIG. 1 is a diagram showing the overall configuration of the device according to an embodiment of this invention.

FIG. 2 is a diagram showing the configuration of the transformer coupling type booster according to an embodiment of this invention.

FIGS. 3A, 3B, 3C, 3D, 3E are time charts showing the contents of switching control, and diagrams showing cases where there is no “zero voltage period.”

FIGS. 4A, 4B, 4C, 4D, 4E are time charts showing the contents of switching control according to an embodiment of this invention, and are diagrams showing cases where control of providing a “zero voltage period” has been added to the switching control shown in FIGS. 3A-3E.

FIGS. 5A, 5B are diagrams corresponding to FIG. 3A, and are diagrams showing cases of the powering status.

FIGS. 6A, 6B are diagrams corresponding to FIG. 4A, and are diagrams showing cases of the powering status.

FIGS. 7A, 7B, 7C, 7D are time charts of the first control.

FIGS. 8A, 8B, 8C, 8D are time charts of the control according to an embodiment of this invention.

FIG. 9 is a diagram showing the relationship between the input voltage and the transformer current peak value.

FIG. 10 is a diagram showing the relationship among the low voltage duty, the high voltage duty and the transformer current effective value.

FIG. 11 is a flowchart of the first control.

FIG. 12 is a graph explaining the first control, and a graph showing the relationship between the phase difference, and the output power and the transformer current effective value.

FIG. 13 is a table showing the comparative results of the first control, the second control, the third control, the fourth control, and the fifth control.

FIG. 14 is a flowchart of the second control.

FIG. 15 a graph explaining the second control, and is a graph showing the relationship of the low voltage duty (=high voltage duty), and the output power and the transformer current effective value.

FIG. 16 is a flowchart of the third control.

FIG. 17 is a graph explaining the third control, and is a graph showing the relationship of the phase difference (=low voltage duty=high voltage duty), and the output power and the transformer current effective value.

FIG. 18 is a flowchart of the fourth control.

FIG. 19 is a graph for comparing the first control, the second control, and the third control, and is a graph showing the relationship of the output power and the transformer current effective value.

FIG. 20 is a graph showing the relationship of the output power and the transformer current effective value, and a graph showing the characteristics of the fifth control.

FIG. 21 is a table illustrating the contents of the data table stored in the controller.

FIG. 22 is a flowchart of the fifth control.

### EXPLANATION OF REFERENCE NUMERALS

30 . . . electrical storage device (capacitor), 50 . . . transformer coupling type booster, 51, 52, 53, 54, 55, 56, 57, 58 . . . switching element, 80 controller.

### BEST MODE FOR CARRYING OUT THE INVENTION

Embodiments of a control device of a transformer coupling type booster are now explained with reference to the appended drawings. Note that, in the ensuing explanation, the transformer coupling type booster of this embodiment is mounted on a hybrid-type construction machine (referred to as the “hybrid construction machine” in this specification), and an electrical storage device is explained as a capacitor.

### First Embodiment

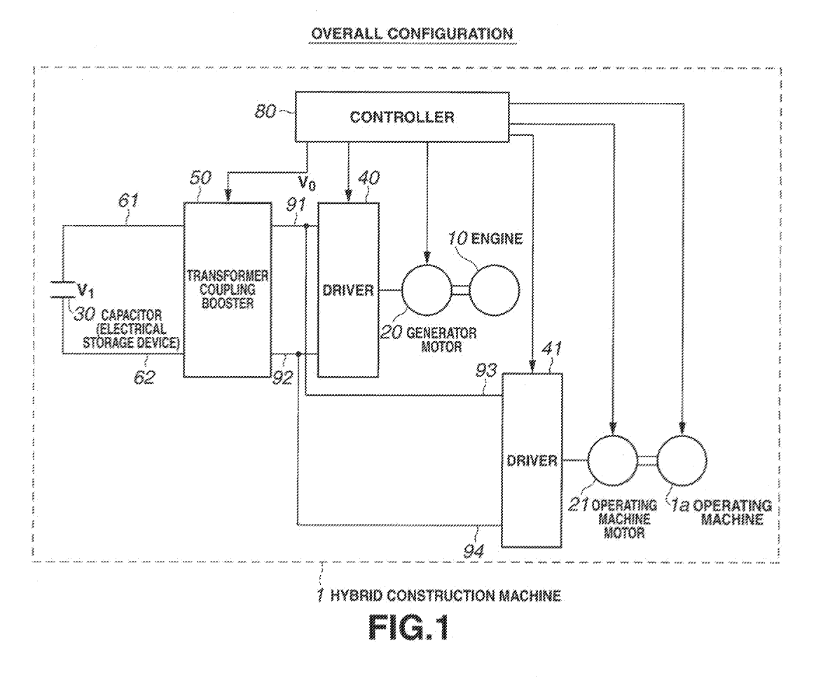

FIG. 1 shows the overall device configuration according to an embodiment of this invention.

As shown in FIG. 1, a hybrid construction machine 1 of this embodiment is mounted with an engine 10, a generator motor 20, a capacitor 30, a driver 40, a transformer coupling type booster 50, and a controller 80. The generator motor 20 is driven by the driver 40. The controller 80 controls the driver 40, the generator motor 20 and the transformer coupling type booster 50.

Moreover, additionally provided is an operating machine motor 21 capable of powering and regenerating an operating machine 1a of the hybrid construction machine 1. The operating machine motor 21 is controlled by the driver 41. The controller 80 controls the driver 41 and the operating machine motor 21.

A drive shaft of the generator motor 20 is connected to an output shaft of the engine 10. The generator motor 20 performs power generating operations and electrical driving operations. As a result of the generator motor 20 performing power generating operations, the capacitor 30 is accumulated with power, or discharges the accumulated power and supplies it to the generator motor 20. The driver 40 drives the generator motor 20. The driver 40 is configured from an inverter which drives the generator motor 20. The transformer coupling type booster 50 is electrically connected to the capacitor 30 via electrical signal lines 61, 62. The transformer coupling type booster 50 boosts an input voltage V1 as the inter-terminal voltage of the capacitor 30 and supplies it as an output voltage V0 to the driver 40. In other words, the transformer coupling type booster 50 boosts the charge voltage V1 of the capacitor 30 and applies the boosted voltage V0 between the signal lines 91, 92. The output voltage V0 of the transformer coupling type booster 50 is supplied to the drive 40 via the signal lines 91, 92.

Upon powering, direct current is discharged from the capacitor 30, that direct current is converted into an alternating current in the transformer coupling type booster 50, the boosted direct current is output to the driver 41, this is converted into an alternating current by the driver 41, and then supplied to the operating machine motor 21.

Meanwhile, upon regeneration, the alternating current that was generated based on the power generating operations of the operating machine motor 21 is converted into a direct current by the driver 41 and input to the transformer coupling type booster 50. This is once converted into an alternating current in the transformer coupling type booster 50, and the direct current is input to (charged in) the capacitor 30.

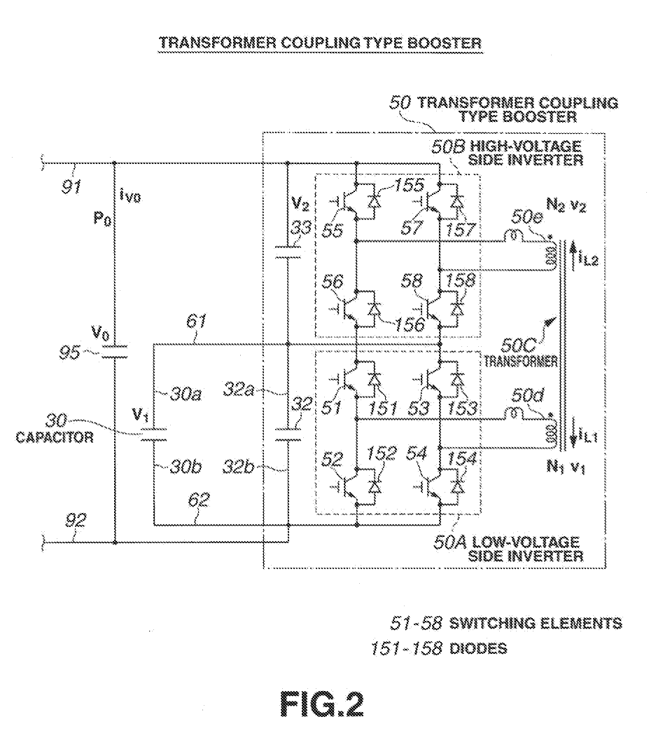

In FIG. 2, V2 is referred to as the high-voltage side inverter DC voltage. Among the high-voltage side inverter DC voltage V2, the voltage V1 before being boosted, and the boosted voltage (output voltage) V0, the following relationship is established.

V2=V0−V1

In other words, the total of the high-voltage side inverter DC voltage V2 and the voltage V1 before being boosted becomes the boosted voltage V0. To put it differently, the high-voltage side inverter DC voltage V2 is a result of subtracting the charge voltage V1 from the output voltage V0. Note that V1 or V2, and V0 represent a DC voltage, and v1 or v2 represents an AC voltage.

Moreover, the output voltage V0 of the transformer coupling type booster 50 is supplied to the driver 41 via signal lines 93, 94, and then supplied to the operating machine motor 21. The operating machine motor 21 performs powering for operating the operating machine 1a. Moreover, the operating machine motor 21 performs power generating operations based on regeneration when the operation of the operating machine 1a is to stop. The generated power thereby passes through the driver 41 and is charged from the signal lines 93, 94 into the capacitor 30 via the transformer coupling type booster 50.

The transformer coupling type booster 50 is configured, for example, from an AC link bidirectional DC-DC converter as described later.

The electric power generation of the generator motor 20 is controlled by the controller 80.

Torque of the generator motor 20 is controlled by the controller 80. The controller 80 issues a torque command to the driver 40 for driving the generator motor 20 at a predetermined torque. The driver 40 receives control signals from the controller 80, and issues a torque command for driving the generator motor 20 at a predetermined torque.

Power that is generated as a result of the generator motor 20 performing power generating operations is thereby accumulated in the capacitor 30. Moreover, the capacitor 30 supplies, to the generator motor 20, the power accumulated in the capacitor 30.

FIG. 2 shows the configuration of the transformer coupling type booster 50 of this embodiment.

The transformer coupling type booster 50 is configured by a low-voltage side inverter 50A and a high-voltage side inverter 50B being coupled via a transformer 50C.

The low-voltage side inverter 50A and the high-voltage side inverter 50B are electrically connected in series so that a positive electrode of the low-voltage side inverter 50A and a negative electrode of the high-voltage side inverter 50B have an additive polarity.

The low-voltage side inverter 50A is configured by including four switching elements 51, 52, 53, 54 which are bridge-connected to a low-voltage side winding 50d of the transformer 50C, and diodes 151, 152, 153, 154 connected parallel to the switching elements 51, 52, 53, 54 so that their polarities are inverted from those of the switching elements. The switching elements 51, 52, 53, 54 are configured, for example, from an IGBT (insulated gate bipolar transistor). The switching elements 51, 52, 53, 54 are turned ON when an ON switching signal is applied to the gate, and a current thereby flows therein.

A positive terminal 30a of the capacitor 30 is electrically connected to a collector of the switching element 51 via a signal line 61. An emitter of the switching element 51 is electrically connected to a collector of the switching element 52. An emitter of the switching element 52 is electrically connected to a negative terminal 30b of the capacitor 30 via a signal line 62.

Similarly, the positive terminal 30a of the capacitor 30 is electrically connected to a collector of the switching element 53 via the signal line 61. An emitter of the switching element 53 is electrically connected to a collector of the switching element 54. An emitter of the switching element 54 is electrically connected to the negative terminal 30b of the capacitor 30 via the signal line 62.

In parallel with the capacitor 30, a positive terminal 32a and a negative terminal 32b of the capacitor 32 for absorbing ripple currents are respectively connected to the signal lines 61, 62.

The emitter (anode of the diode 151) of the switching element 51 and the collector (cathode of the diode 152) of the switching element 52 are connected to one terminal of a low-voltage side winding 50d of the transformer 50C, and the emitter (anode of the diode 153) of the switching element 53 and the collector (cathode of the diode 154) of the switching element 54 are connected to another terminal of the low-voltage side winding 50d of the transformer 50C.

The emitter (anode of the diode 152) of the switching element 52 and the emitter (anode of the diode 154) of the switching element 54; that is, the signal line 62 and the negative terminal 30b of the capacitor 30 are electrically connected to the driver 40 via a signal line 92.

The high-voltage side inverter 50B is configured by including four switching elements 55, 56, 57, 58 which are bridge-connected to a high-voltage side winding 50e of the transformer 50C, and diodes 155, 156, 157, 158 connected parallel to the switching elements 55, 56, 57, 58 so that their polarities are inverted from those of the switching elements. The switching element 55, 56, 57, 58 are configured, for example, from an IGBT (insulated gate bipolar transistor). The switching elements 55, 56, 57, 58 are turned ON when an ON switching signal is applied to the gate, and a current thereby flows therein.

A collector of the switching elements 55, 57 is electrically connected to the driver 40 via a signal line 91. An emitter of the switching element 55 is electrically connected to a collector of the switching element 56. An emitter of the switching element 57 is electrically connected to a collector of the switching element 58. An emitter of the switching elements 56, 58 is electrically connected to the signal line 61; that is, a collector of the switching elements 51, 53 of the low-voltage side inverter 50A.

As with the low-voltage side inverter 50A, a capacitor 33 for absorbing ripple currents is electrically connected respectively to the switching elements 55, 56 and the switching elements 57, 58 in parallel.

The emitter (anode of the diode 155) of the switching element 55 and the collector (cathode of the diode 156) of the switching element 56 are connected to one terminal of a high-voltage side winding 50e of the transformer 50C, and the emitter (anode of the diode 157) of the switching element 57 and the collector (cathode of the diode 158) of the switching element 58 are connected to another terminal of the high-voltage side winding 50e of the transformer 50C.

Contents of the control performed by the controller 80 are now explained.

The controller 80 applies ON/OFF switching signals to the respective switching elements 51 to 58, and performs switching control of alternately repeating, at a predetermined cycle Ts, a voltage positive polarity period where an inter-terminal voltage v1 of the low-voltage side winding 50d and an inter-terminal voltage v2 of the high-voltage side winding 50e have a positive polarity, and a voltage negative polarity period where those inter-terminal voltages have a negative polarity.

Upon performing the foregoing switching control, added is control of providing a zero voltage period (T−TL to v1, and T-TH to v2) between the voltage positive polarity period and the voltage negative polarity period of the inter-terminal voltage v1 of the low-voltage side winding 50d and the inter-terminal voltage v2 of the high-voltage side winding 50e in order to reduce the transformer effective current value iL. In the foregoing case, the zero voltage period (T−TL to v1, and T-TH to v2) is formed between the voltage positive polarity period and the voltage negative polarity period of the inter-terminal voltage v1 of the low-voltage side winding 50d and the inter-terminal voltage v2 of the high-voltage side winding 50e by providing a phase difference between the respective switching signals to be applied to the respective switching elements 51 to 54 configuring the low-voltage side inverter 50A and providing a phase difference between the respective switching signals to be applied to the respective switching elements 55 to 58 configuring the high-voltage side inverter 50B.

The contents of this control are now explained. Note that, in the ensuing explanation, a dead time is not considered. The dead time is the period that both the upper and lower switching elements in FIG. 2 are OFF in the respective switching elements in order to prevent a short circuit.

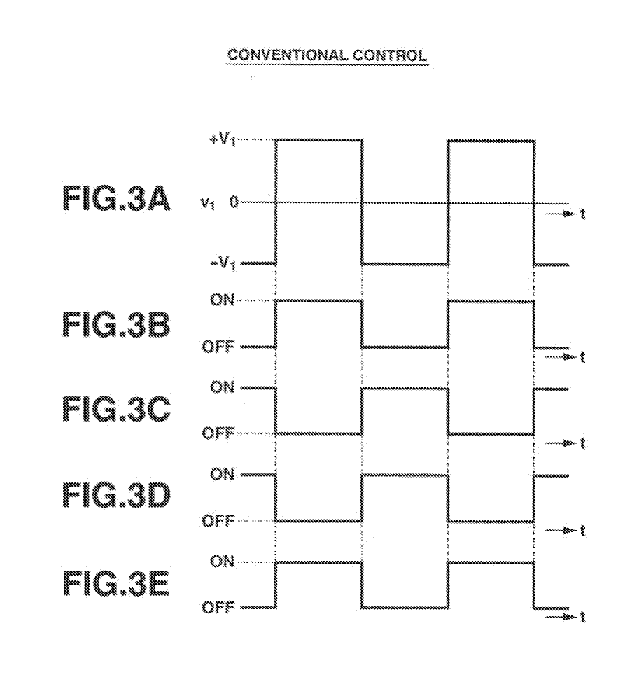

FIGS. 3A-3E are time charts showing the contents of the switching control, and shows a case where there is no “zero voltage period.” FIGS. 3B, 3C, 3D, 3E respectively show the time change of the switching signals (ON/OFF) that are provided to the respective switching elements 51, 52, 53, 54 configuring the low-voltage side inverter 50A, and FIG. 3A shows the time change of the inter-terminal voltage v1 of the low-voltage side winding 50d that is generated based on the foregoing switching signals.

In the ensuing explanation, the switching control shown in FIGS. 3A-3E is referred to as the “first control” (conventional control).

As shown in FIGS. 3B, 3E, switching signals of repeating ON/OFF every half cycle are provided to the switching elements 51, 54, and the switching elements 51, 54 are subject to the repetition of being turned ON during the period of half cycle T=½ Ts, and subsequently being turned OFF during the period of half cycle T=½ Ts.

Moreover, as shown in FIGS. 3C, 3D, applied to the switching elements 52, 53 are switching signals in which ON/OFF is reversed in comparison to the switching signals that are applied to the switching elements 51, 54. Consequently, the switching elements 52, 53 are subject to the repetition of being turned OFF during the period of half cycle T=½ Ts when the switching elements 51, 54 are turned ON, and subsequently being turned ON during the period of half cycle T=1/2 Ts when the switching elements 51, 54 are turned OFF.

Consequently, as shown in FIG. 3A, the inter-terminal voltage v1 of the low-voltage side winding 50d is subject to the repetition of becoming a voltage maximum value +V1 of a positive polarity during the period of half cycle T=½ Ts, and subsequently becoming a voltage maximum value −V1 of a negative polarity during the period of half cycle T=½ Ts. In the foregoing case, a zero voltage period is not formed between the voltage positive polarity period and the voltage negative polarity period.

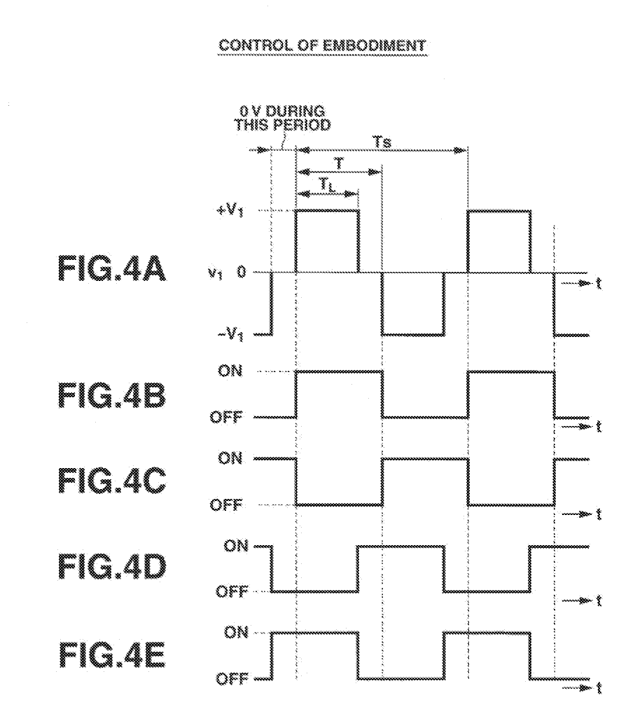

FIGS. 4A-4E are time charts showing the contents of the switching control of this embodiment, and shows a case where control of providing a “zero voltage period” has been added to the switching control shown in FIGS. 3A-3E.

FIGS. 4B, 4C, 4D, 4E respectively show the time change of the switching signals (ON/OFF) that are provided to the respective switching elements 51, 52, 53, 54 configuring the low-voltage side inverter 50A, and FIG. 4A shows the time change of the inter-terminal voltage v1 of the low-voltage side winding 50d that is generated by the foregoing switching signals.

As shown in FIGS. 4B, 4C, switching signals in which ON/OFF are mutually reversed are applied to the switching elements 51, 52 as same in FIGS. 3A, 3B. Moreover, as shown in FIGS. 4D, 4E, switching signals in which ON/OFF are mutually reversed are applied to the switching elements 53, 54 as same in FIGS. 3D, 3E.

However, as shown in FIGS. 4B, 4D, the phase difference of the switching signals applied to the switching elements 51, 53 is of a different value than the phase difference of the switching signals applied to the switching elements 51, 53 in FIGS. 3B, 3D. The phase difference of the switching signals applied to the switching elements 51, 53 in FIGS. 3B, 3D was T=½ Ts; that is, that phase difference of a half cycle where ON/OFF is reversed. Meanwhile, the phase difference of the switching signals applied to the switching elements 51, 53 in FIGS. 4B, 4D is TL (<T=½ Ts), and is causing the switching signals applied to the switching element 53 to be delayed by TL than the switching signals applied to the switching element 51.

Consequently, as shown in FIG. 4A, the inter-terminal voltage v1 of the low-voltage side winding 50d becomes a voltage maximum value +V1 of a positive polarity during the period of TL. Subsequently, since the switching elements 51, 53 are simultaneously turned ON during the period of T−TL, it becomes zero voltage during the foregoing period of T−TL. Subsequently, it becomes a voltage maximum value −V1 of a negative polarity during the period of TL. The foregoing is repeated. A zero voltage period T−TL is thereby formed between the voltage positive polarity period and the voltage negative polarity period.

As described above, FIGS. 3A-3E and FIGS. 4A-4E explained the operation in the low-voltage side inverter 50A, but the same operation is also performed in the high-voltage side inverter 50B. Note that, although the period of T−TL is made to be zero voltage by simultaneously turning ON the switching elements 51, 53 during the period of T−TL, it is also possible to realize the zero voltage of the period of T−TL by simultaneously turning ON the switching elements 52, 54 during the period of T−TL.

The control of the output voltage V0 and the output power P0 is now explained.

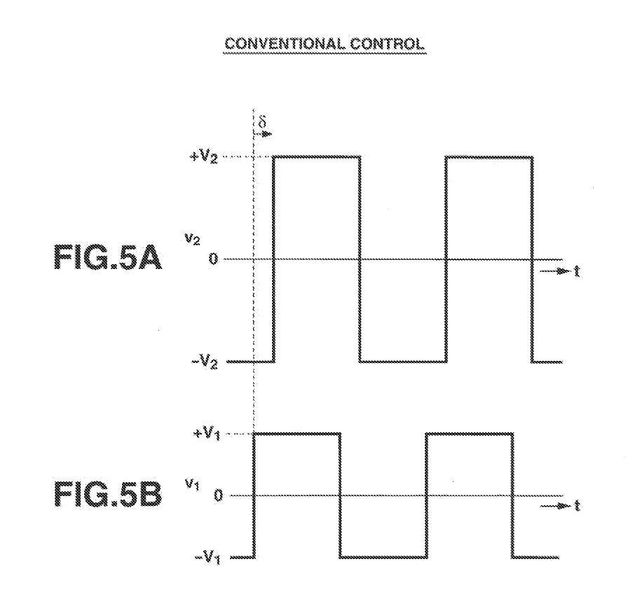

FIGS. 5A, 5B are diagrams corresponding to FIG. 3A, and shows a case of the powering status. FIG. 5A shows the time change of the inter-terminal voltage v2 of the high-voltage side winding 50e, and FIG. 5B shows the time change of the inter-terminal voltage v1 of the low-voltage side winding 50d.

As shown in FIGS. 5A, 5B, the powering status is realized by causing the phase of the signals of the inter-terminal voltage v1 of the low-voltage side winding 50d to advance a predetermined δ period relative to the phase of the inter-terminal voltage v2 of the high-voltage side winding 50e. Note that the regeneration status is realized by causing the phase of the signals of the inter-terminal voltage v2 of the high-voltage side winding 50e to advance a predetermined δ period relative to the phase of the inter-terminal voltage v1 of the low-voltage side winding 50d.

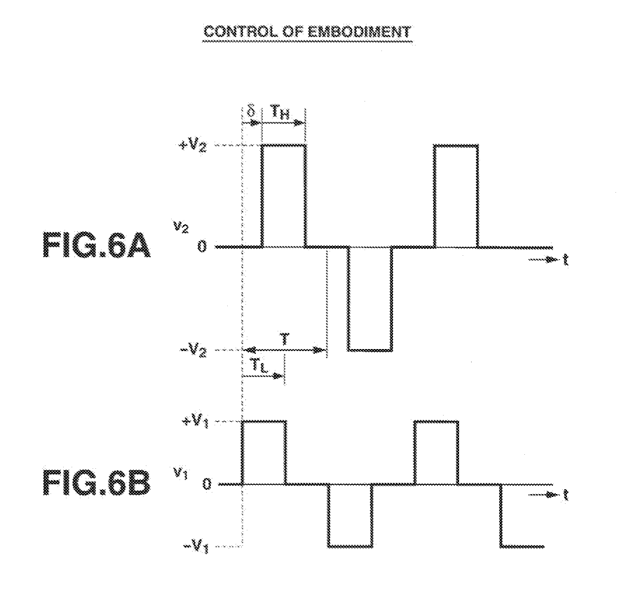

FIGS. 6A, 6B is a diagram corresponding to FIG. 4A, and shows a case of the powering status. FIG. 6A shows the time change of the inter-terminal voltage v2 of the high-voltage side winding 50e, and FIG. 6B shows the time change of the inter-terminal voltage v1 of the low-voltage side winding 50d.

As shown in FIGS. 6A, 6B, the powering status is realized by causing the phase of the signals of the inter-terminal voltage v1 of the low-voltage side winding 50d to advance a predetermined δ period relative to the phase of the inter-terminal voltage v2 of the high-voltage side winding 50e. Note that the regeneration status is realized by causing the phase of the signals of the inter-terminal voltage v2 of the high-voltage side winding 50e to advance a predetermined δ period relative to the phase of the inter-terminal voltage v1 of the low-voltage side winding 50d.

Note that the parameters of phase difference ratio d, low voltage duty dL, and high voltage duty dH are defined and these parameters are adjusted, but parameters other than the phase difference ratio d can be used so as long as it is a parameter that can adjust the phase difference δ. Moreover, parameters other than the low voltage duty dL can be used so as long as it is a parameter that can adjust the period (T−TL) where the inter-terminal voltage v1 of the low-voltage side winding 50d becomes zero, and parameters other than the high voltage duty dH can be used so as long as it is a parameter that can adjust the period (T−TL) where the inter-terminal voltage v2 of the high-voltage side winding 50e becomes zero.

The polarity of the phase difference δ during the powering status is defined as positive, and the polarity of the phase difference δ during the regeneration status is defined as negative.

In FIGS. A, 5B5 and FIGS. 6A, 6B, the ratio of the phase difference δ relative to the half cycle T

d=δ/T

is referred to as the phase difference ratio.

Thus, when the phase difference ratio d is

d>0

it becomes a powering status. Moreover, when the phase difference ratio d is

d<0

it becomes a regeneration status. Moreover, when the phase difference ratio d is

d=0

it becomes a no load status.

The phase difference δ shown in FIGS. 5A, 5B can be obtained as follows. In other words, the output voltage target value is set as V0*, and the output voltage that was measured by a voltage sensor not shown as the actual output voltage is set as V0. The controller 80 obtains the deviation of the output voltage target value V0* and the output voltage V0. The controller 80 operates to perform PI control according to the obtained deviation, and calculates the phase difference δ. In other words, the phase difference δ is obtained based on feedback control. The output power P0 will fluctuate depending on the size of the value of the phase difference ratio d as the ratio relative to the half cycle T of the phase difference δ. If there is no phase difference δ, since the phase difference ratio d as the ratio relative to the half cycle T of the phase difference δ will consequently become zero, the output power P0 is not generated.

During powering, the phase difference δ takes on a positive value, and, as shown in FIGS. 5A, 5B, the inter-terminal voltage v1 of the low-voltage side winding is advanced in the amount of the phase difference δ relative to the high-voltage side inter-terminal voltage v2. Meanwhile, during regeneration, the phase difference δ takes on a negative value, and the inter-terminal voltage v1 of the low-voltage side winding is delayed in the amount of the phase difference δ relative to the inter-terminal voltage v2 of the high-voltage side winding.

In FIGS. 6A, 6B, the ratio of half cycle T of the period TL where the inter-terminal voltage v1 of the low-voltage side winding 50d becomes a positive polarity voltage +V1; that is,

dL=TL/T

is referred to as the low-voltage side voltage duty. When dL=1 and dH=1, it coincides with the conventional control (FIGS. 5A, 5B).

Moreover, the ratio of half cycle T of the period TH where the inter-terminal voltage v2 of the high-voltage side winding 50e becomes a positive polarity voltage +V2; that is,

dH=TH/T

is referred to as the high-voltage side voltage duty. When dL=1 and dH=1, it coincides with the conventional control (FIGS. 5A, 5B).

Now, as described above, the increase of reactive current leads to the increase of transformer effective current and the increase of current flowing in the switching element, and consequently leads to the increase of energy loss since the current is lost as heat.

Nevertheless, in the present invention, by changing the respective parameters of the foregoing phase difference ratio d, low-voltage side voltage duty dL, and high-voltage side voltage duty dH according to the characteristics or operating conditions of the transformer coupling type booster 50, the reactive current can be reduced relative to the same output power and low-loss operation is thereby enabled. In the foregoing case, since it is only necessary to change the switching signals and there is no need to change the elements and units configuring the power circuit such as the switching elements and transformers, the present invention can be applied easily. However, there are cases where the circuit of the controller 80 needs to be changed. The circuit of the controller 80 is different from a power circuit or a main circuit.

Next, with the first control (conventional control) as the comparative example, the relationship of the respective parameters d, dL, dH and the reactive current, and energy loss is now explained.

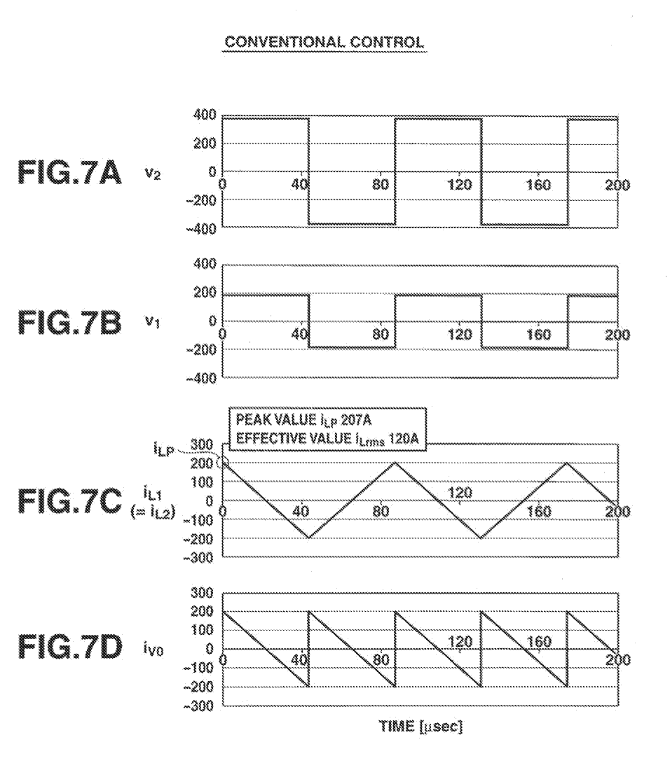

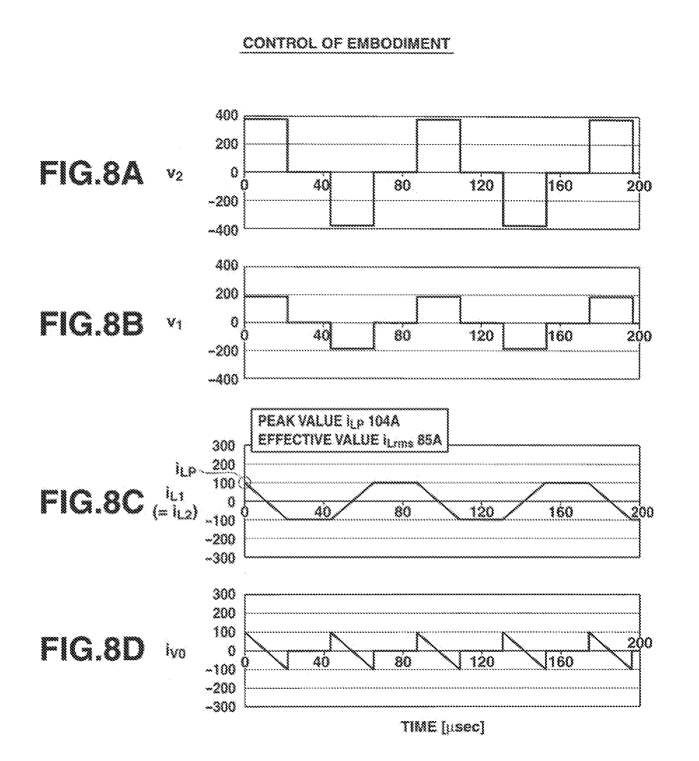

FIGS. 7A-7D show the first control (conventional control), and FIGS. 8A-8D show the control of this embodiment. These are compared with both in a no load status; that is, where the phase difference ratio d is 0. In the control of this embodiment, the low voltage duty dL and the high voltage duty dH were set to 0.5.

Here, a reactive current is generated even in a no load status (phase difference δ=0, or the phase difference ratio d as the ratio relative to the half cycle T of the phase difference δ is phase difference ratio d=0) so as long as there is a difference between the inter-terminal voltage v1 of the low-voltage side winding and the inter-terminal voltage v2 of the high-voltage side winding. In other words, even in that status where the operating machine motor 21 is performing neither powering nor regeneration, a reactive current is generated from the relationship of the following formula. Irrespective of the phase difference δ, the variation of the transformer current iL per unit time can be obtained with the following formula.

diL/dt=(v1−v2)/L

iL: transformer current

L: leakage inductance

Here, the transformer current iL is the transformer current iL in the case where the transformer turns ratio N2/N1 (=1). Even in a no load status, a difference as shown in FIGS. 7A, 7B is generated between the inter-terminal voltage v1 of the low-voltage side winding and the inter-terminal voltage v2 of the high-voltage side winding, and, based on the foregoing formula, the transformer current iL (=iL1=iL2) per unit time will flow into the transformer coupling type booster, and this flowing current becomes a reactive current, which is loss.

In the control of this embodiment, the operating conditions were set to the following operating conditions 1.

### (Operating Conditions 1)

The setting was as follows.

Switching frequency fs: 11.5 kHz

Switching signal cycle Ts: 87.0 μsec

Transformer turns ratio N2/N1: 1

Leakage inductance: 20 μH

Output voltage V0: 550 V

FIGS. 7A-7D are time charts of the first control (conventional control: dL=dH=1), and FIGS. 7A, 7B, 7C, 7D respectively show the respective time changes of the inter-terminal voltage v2 of the high-voltage side winding 50e, the inter-terminal voltage v1 of the low-voltage side winding 50d, the transformer current iL (current peak value iLp and transformer current effective value iLrms), and the output current iV0.

In a no load status as shown in FIGS. 7A, 7B, since the phase difference δ as shown in FIG. 5 is not generated, the inter-terminal voltage v2 of the high-voltage side winding and the inter-terminal voltage v1 of the low-voltage side winding will undergo transition at the same phase.

FIGS. 8a-8d are time charts of the control (dL=dH=0.5) of this embodiment, and FIGS. 8A, 8B, 8C, 8D respectively show the time changes of the inter-terminal voltage v2 of the high-voltage side winding 50e, the inter-terminal voltage v1 of the low-voltage side winding 50d, the transformer current iL (current peak value iLp and transformer current effective value iLrms), and the output current iV0.

Here, the transformer current peak value iLp is the peak value of the current iL1 that is flowing in the low-voltage side winding 50d of the transformer 50C, and the transformer current effective value iLrms is the effective value of the current iL1 that is flowing in the low-voltage side winding 50d of the transformer 50C. In the foregoing case, since the turns ratio N1/N2=1 based on the characteristics of the transformer, the transformer current iL=iL1=iL2, and it is not always iL1=iL2.

Moreover, the output current iV0 is the current that is flowing in the signal lines 91, 92. The product of the output current iV0 and the output voltage V0 becomes the output power P0 (=iV0·V0).

Upon comparing FIGS. 7A-7D and FIGS. 8A-8D, while the output power P0 is 0 kW in the same no load status, as a result of reducing the low voltage duty dL and high voltage duty dH from 1 (first control; conventional control) to 0.5 (control of this embodiment), the transformer current peak value iLp and the transformer current effective value iLrms can be reduced.

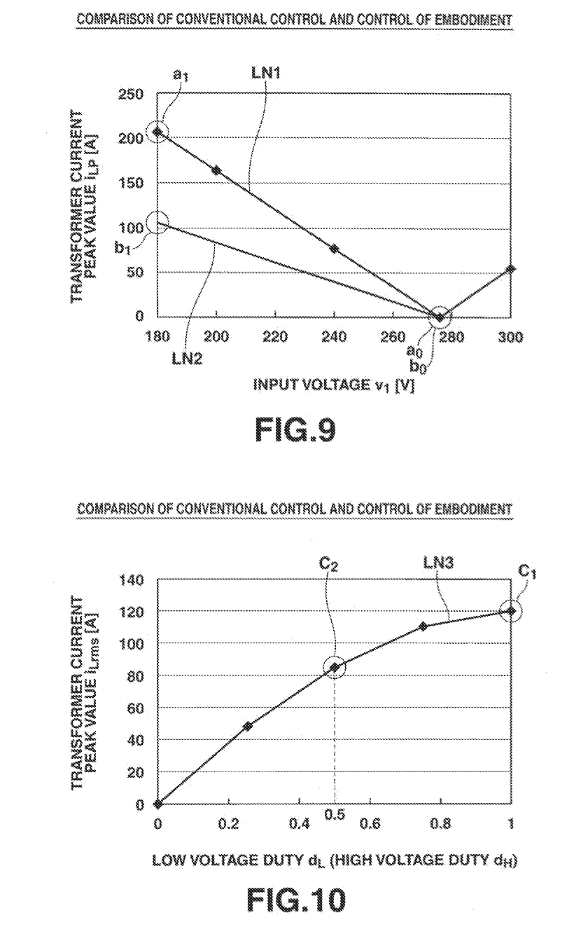

FIG. 9 is a diagram showing the relationship of the input voltage V1 and the transformer current peak value iLp. FIG. 9 shows the characteristics of the operation based on the foregoing operating conditions 1, and shows a case of no load (phase difference ratio d=0).

In FIG. 9, LN1 represents the characteristics of the first control (conventional control), and LN2 represents the characteristics of the control of this embodiment.

Point a0 in the characteristics LN1 of the conventional control is an equilibrium point, and is the point where operation is performed with the voltage conditions (V1=V2=275 V) where the transformer turns ratio N2/N1 (=1) becomes equivalent to the transformer voltage ratio V2/V1 (=V0−V1/V1=(550 V-275 V)/275 V=1). With the equilibrium point, the transformer current peak value iLp takes on the minimum value 0 A, and is reduced the most. Similarly, point b0 in the characteristics LN2 of the control of this embodiment is an equilibrium point, and the transformer current peak value iLp takes on a minimum value 0 A, and is reduced the most.

Now, let it be assumed that operation is performed at point a1 that is displaced from the equilibrium point in the characteristics LN1 of the conventional control. The operation at this point a1 corresponds to FIG. 7. Here, the transformer turns ratio N2/N1 (=1) becomes the most disassociated from the value of the transformer voltage ratio V2/V1 (=V0−V1/V1=(550 V-180 V)/180 V), and the two will no longer coincide. When operation is performed at point a1 of the voltage conditions (V1=180 V, V2=370 V) that is most displaced from the equilibrium point as described above, the transformer current peak value iLp takes on the maximum value 207A, and is increased the most.

Meanwhile, with the control of this embodiment, while operation is performed at a point that is displaced from the equilibrium point, as a result of performing the operation on the characteristics LN2, the transformer current peak value iLp will reduce in comparison to the case of performing the operation on the characteristics LN1. In other words, the control (FIG. 8) of this embodiment corresponds to performing the operation at point b1 on LN2. Here, the transformer turns ratio N2/N1 (=1) becomes the most disassociated from the value of the transformer voltage ratio V2/V1 (=V0−V1/V1=(550 V−180 V)/180 V), and the two will no longer coincide (voltage conditions; V1=180 V, V2=370 V). However, the transformer current peak value iLp becomes 104A, and can be considerably reduced in comparison to the transformer current peak value (207A) of the conventional control.

FIG. 10 shows the relationship of the low voltage duty dL, the high voltage duty dH and the transformer current effective value iLrms. FIG. 10 shows the characteristics in the case of performing the operation based on the foregoing operating conditions 1, and shows a case where there is no load (phase difference ratio d=0), and the input voltage V1 (low-voltage side winding inter-terminal voltage maximum value V1) is 180 V.

In FIG. 10, point c1 on the characteristics LN3 corresponds to the case of the conventional control (dL=dH=1) shown in FIG. 7, and point c2 on the characteristics LN3 corresponds to the case of the control (dL=dH=0.5) of this embodiment shown in FIG. 8. FIG. 10 shows that, as the low voltage duty dL and the high voltage duty dH are reduced, the transformer current effective value iLrms is also reduced.

As described above, according to this embodiment, since the switching control is added with control of providing a zero voltage period (T−TL) between the voltage positive polarity period and the voltage negative polarity period of the inter-terminal voltage v1 of the low-voltage side winding 50d and the inter-terminal voltage v2 of the high-voltage side winding 50e, the low voltage duty dL and the high voltage duty dH can be reduced, and the transformer effective current value iL can be consequently reduced. Consequently, the reactive current can be reduced, the generation of heat in the transformer 50C, the switching elements 51, 52 . . . and the like can be inhibited, the energy that is accumulated as the input voltage V1 in the capacitor 30 can be effectively used for a task, wasteful energy consumption in the circuit of the transformer coupling type booster 50 can be inhibited, and energy loss can be inhibited.

The foregoing explanation was based on the assumption that the control of providing a zero voltage period (T−TL) is performed for both the inter-terminal voltage v1 of the low-voltage side winding 50d and the inter-terminal voltage v2 of the high-voltage side winding 50e. Nevertheless, it is also possible to perform the control of providing a zero voltage period (T−TL) to either only the inter-terminal voltage v1 of the low-voltage side winding 50d or the inter-terminal voltage v2 of the high-voltage side winding 50e.

In other words, upon the controller 80 performing the switching control, added may be control of providing a zero voltage period (T−TL) between the voltage positive polarity period and the voltage negative polarity period of the inter-terminal voltage v1 of the low-voltage side winding 50d or the inter-terminal voltage v2 of the high-voltage side winding 50e in order to reduce the transformer effective current value iL. In the foregoing case, the zero voltage period (T−TL) is formed between the voltage positive polarity period and the voltage negative polarity period of the inter-terminal voltage v1 of the low-voltage side winding 50d or the inter-terminal voltage v2 of the high-voltage side winding 50e by providing a phase difference between the respective switching signals to be applied to the respective switching elements 51 to 54 configuring the low-voltage side inverter 50A, or providing a phase difference between the respective switching signals to be applied to the respective switching elements 55 to 58 configuring the high-voltage side inverter 50B.

### Second Embodiment

Now, in order to exhibit practical functions as the transformer coupling type booster 50, it is necessary to perform optimal control while giving consideration to various items such as “continuous switching between powering and regeneration,” “output limit,” “loss based on light load at a point away from the equilibrium point,” and “loss at equilibrium point.”

Thus, tests were conducted by variously changing the respective parameters d, dL, dH described above in order to search for the optimal control. Note that, in the ensuing explanation, all controls are explained as example that were implemented under the foregoing operating conditions 1.

Values of the phase difference ratio d, the low voltage duty dL, and the high voltage duty dH were changed and first control (conventional control), second control, third control, fourth control, and fifth control were implemented, and their results were examined Consequently, it was discovered that the transformer effective current value iLrms can be reduced by optimally adjusting the phase difference ratio d, the low voltage duty dL, and the high voltage duty dH as parameters. This is explained below.

First Control:

This is the control of setting the low voltage duty dL and the high voltage duty dH to 1 (dL=dH=1).

Second Control:

This is the control of setting the phase difference ratio d to be constant at 0.5 (d=0.5).

Third control:

This is the control of setting the phase difference ratio d, the low voltage duty dL, and the high voltage duty dH to be equal (d=dL=dH).

Fourth Control:

This is the control of combining and simultaneously using the second control and the third control.

Fifth Control:

This is the control of setting the optimal combination of the phase difference ratio d, the low voltage duty dL, and the high voltage duty dH in advance according to the input voltage V1, and performing the control by reading the settings. Although the contents of the control will differ depending on the operating conditions, for example, control corresponding to the third control is performed during a low load, and control corresponding to the conventional control is performed during a high load.

### (First Control)

In the first control, the low voltage duty dL and the high voltage duty dH are fixed to 1, and the phase difference ratio d is changed within the range of

−0.5≦d≦0.5

according to the load. It is thereby possible to deal with the “continuous switching between powering and regeneration.”

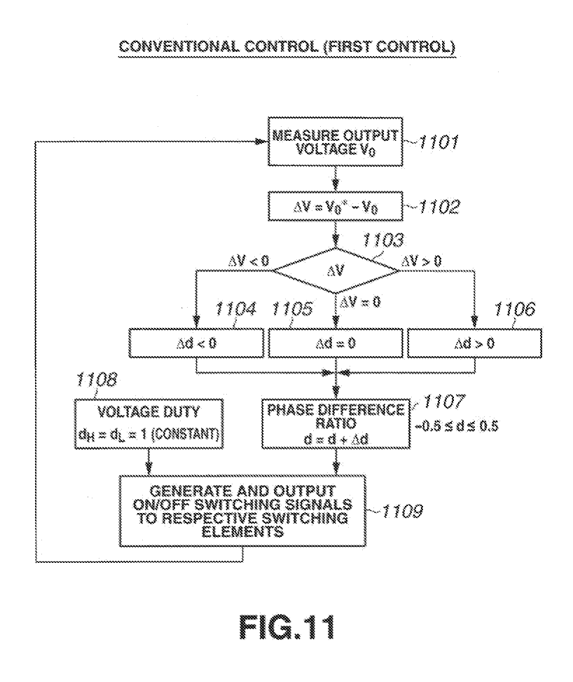

The controller 80 implements the first control according to the flowchart shown in FIG. 11.

In other words, the controller 80 measures the current output voltage V0 (step 1101), feeds back the current output voltage V0 that was measured, and computes the deviation ΔV=V0*−V0 of the output voltage target value V0*(550 V) and the current value (step 1102). Subsequently, according to whether the deviation ΔV is ΔV<0 or ΔV=0 or ΔV>0 (step 1103), the variation Δd of the phase difference ratio d is obtained (steps 1104, 1105, 1106). In other words, when it is ΔV<0, the variation Δd of the phase difference ratio d is set to a predetermined decrement Δd (<0) of a negative polarity (step 1104). When it is ΔV=0, the variation Δd of the phase difference ratio d is not increased or decreased; that is, it is set to Δd=0 (step 1105). When it is ΔV>0, the variation Δd of the phase difference ratio d is set to a predetermined increment Δd(>0) of a positive polarity (step 1106).

Next, the phase difference variation Δd that was obtained in steps 1104, 1105, 1106 is added to the current phase difference ratio d, and the current phase difference ratio d is updated (d←d+Δd). However, the phase difference ratio d is changed within the range of −0.5≦d≦0.5 (step 1107).

Next, the pre-set value 1 (fixed value) of the low voltage duty dL and the high voltage duty dH is read (step 1108), and the controller 80 generates and outputs the switching signals to be applied to the respective switching elements 51 to 58 to achieve the respective values of the phase difference ratio d, the low voltage duty dL, and the high voltage duty dH based on the read value 1 (fixed value) of the low voltage duty dL and the high voltage duty dH, and the phase difference ratio d that was updated in step 1107. Consequently, the ON/OFF operation of the respective switching elements 51 to 54 (or 55 to 58) is performed as shown in FIGS. 3B, 3C, 3D, 3E, the ON/OFF operation of the low voltage winding inter-terminal voltage v1 (or high voltage inter-terminal voltage v2) is performed as shown in FIG. 3A, and becomes a powering status or a regeneration status as shown in FIGS. 5A, 5B (step 1109).

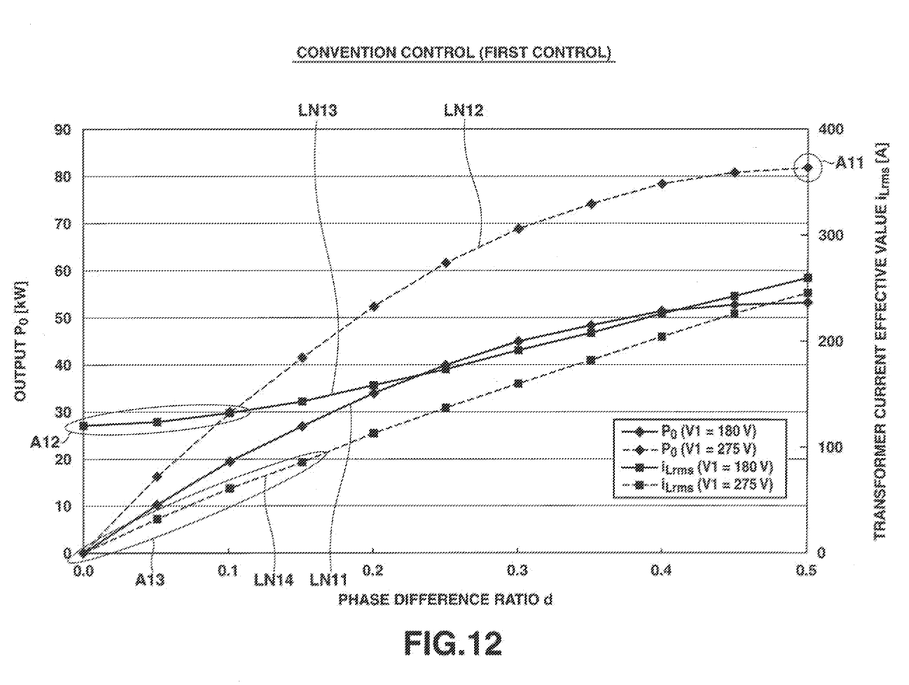

FIG. 12 is a graph explaining the first control. The horizontal axis of FIG. 12 is the phase difference ratio d, the left vertical axis is the output power P0 (kW), and the right vertical axis is the transformer current effective value iLrms (A). FIG. 12 shows the characteristics LN11 of the output power P0 of a case (voltage conditions at a point away from the equilibrium point) where the input voltage V1 (low-voltage side winding inter-terminal voltage maximum value V1) is 180 V, the characteristics LN12 of the output power P0 of a case (voltage conditions at the equilibrium point) where the input voltage V1 (low-voltage side winding inter-terminal voltage maximum value V1) is 275 V, the characteristics LN13 of the transformer current effective value iLrms of a case (voltage conditions at a point away from the equilibrium point) where the input voltage V1 (low-voltage side winding inter-terminal voltage maximum value V1) is 180 V, and the characteristics LN14 of the transformer current effective value iLrms of a case (voltage conditions at the equilibrium point) where the input voltage V1 (low-voltage side winding inter-terminal voltage maximum value V1) is 275 V.

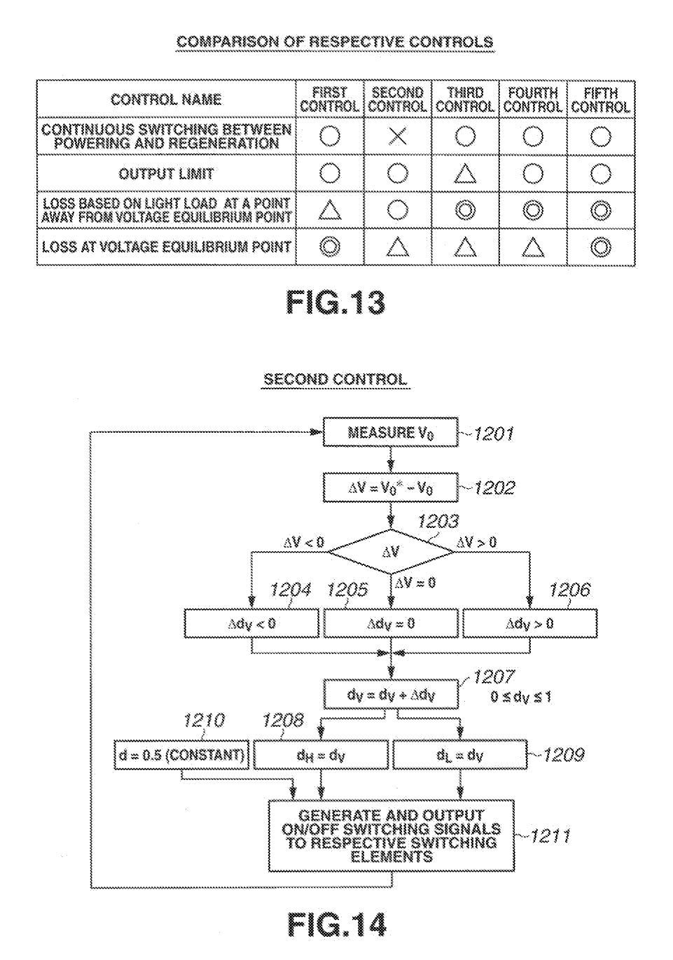

The comparative results of the first control and the other controls are shown in FIG. 13.

As evident from the comparative results of the respective controls shown in FIG. 13, the “continuous switching between powering and regeneration” can be achieved (◯) by changing the phase difference ratio d, the “output limit” is high (◯) as shown in part All of FIG. 12, and, although the “loss based on light load at a point away from the equilibrium point” is slightly great (Δ) as shown in part A12, the “loss at equilibrium point” was extremely small (⊚) as shown in part A13.

### (Second Control)

In the second control, the phase difference ratio d is fixed to be constant at 0.5, and the low voltage duty dL and the high voltage duty dH are changed according to the load. In the foregoing case, since the polarity of the phase difference ratio d is fixed to a constant value (0.5) on the positive side, regeneration cannot be achieved. Note that, if the phase difference ratio d is set to be constant at −0.5, regeneration can be achieved, but powering cannot be performed. Thus, the second control is unable to deal with the “continuous switching between powering and regeneration.”

The controller 80 implements the second control according to the flowchart shown in FIG. 14. As one example, explained is a case of setting the low voltage duty dL and the high voltage duty dH as dv (voltage duty), and changing the voltage duty dv (=dL=dH) within the following range of

0≦dv≦1.

In other words, the controller 80 measures the current output voltage V0 (step 1201), feeds back the current output voltage V0 that was measured, and computes the deviation ΔV=V0*−V0 of the output voltage target value V0*(550 V) and the current value (step 1202). Subsequently, according to whether the deviation ΔV is ΔV<0 or ΔV=0 or ΔV>0 (step 1203), the variation Δdv of the voltage duty dv is obtained (steps 1204, 1205, 1206). In other words, when it is ΔV<0, the variation Δdv of the voltage duty dv is set to a predetermined decrement Δdv(<0) of a negative polarity (step 1204). When it is ΔV=0, the variation Δdv of the voltage duty dv is not increased or decreased; that is, it is set to Δdv=0 (step 1205). When it is ΔV>0, the variation Δdv of the voltage duty dv is set to a predetermined increment Δdv (>0) of a positive polarity (step 1206).

Next, the variation Δdv of the voltage duty dv that was obtained in steps 1204, 1205, 1206 is added to the current voltage duty dv, and the current voltage duty dv is updated (dv←dv+Δdv). However, the voltage duty dv is changed within the range of 0≦dv≦1 (step 1207).

Next, the voltage duty dv that was updated in step 1207 is returned to the high voltage duty dH and the low voltage duty dL (dH=dv, dL=dv; steps 1208, 1209).

Next, the pre-set value 0.5 (fixed value) of the phase difference ratio d is read (step 1210), and the controller 80 generates and outputs the switching signals to be applied to the respective switching elements 51 to 58 to achieve the respective values of the low voltage duty dL, the high voltage duty dH, and the phase difference ratio d based on the read value 0.5 (fixed value) of the phase difference ratio d, and the high voltage duty dH and the low voltage duty dL that were obtained in steps 1208, 1209. Consequently, the ON/OFF operation of the respective switching elements 51 to 54 (or 55 to 58) is performed as shown in FIGS. 4B, 4C, 4D, 4E, the ON/OFF operation of the low voltage winding inter-terminal voltage v1 (or high voltage inter-terminal voltage v2) is performed as shown in FIG. 4A, and becomes a powering status or a regeneration status as shown in FIGS. 6A, 6B (step 1211).

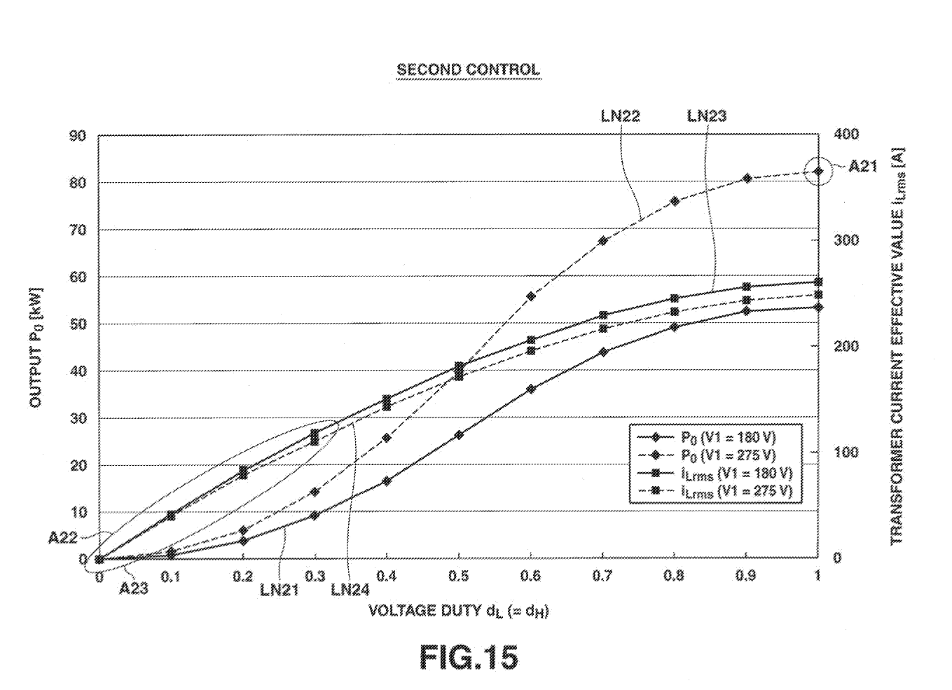

FIG. 15 is a graph explaining the second control. The horizontal axis of FIG. 15 is the low voltage duty dL (=high voltage duty dH), the left vertical axis is the output power P0 (kW), and the right vertical axis is the transformer current effective value iLrms (A). FIG. 15 shows the characteristics LN21 of the output power P0 of a case (voltage conditions at a point away from the equilibrium point) where the input voltage V1 (low-voltage side winding inter-terminal voltage maximum value V1) is 180 V, the characteristics LN22 of the output power P0 of a case (voltage conditions at the equilibrium point) where the input voltage V1 (low-voltage side winding inter-terminal voltage maximum value V1) is 275 V, the characteristics LN23 of the transformer current effective value iLrms of a case (voltage conditions at a point away from the equilibrium point) where the input voltage V1 (low-voltage side winding inter-terminal voltage maximum value V1) is 180 V, and the characteristics LN24 of the transformer current effective value iLrms of a case (voltage conditions at the equilibrium point) where the input voltage V1 (low-voltage side winding inter-terminal voltage maximum value V1) is 275 V.

The comparative results of the second control and the other controls are shown in FIG. 13.

As evident from the comparative results of the respective controls shown in FIG. 13, the “continuous switching between powering and regeneration” was impossible (x) since the phase difference ratio d was fixed to be constant at 0.5, the “output limit” was equally high (◯) as with the first control as shown in part A21 of FIG. 15, and the “loss based on light load at a point away from the equilibrium point” becomes smaller (◯) than the first control as shown in part A22. Nevertheless, as shown in part A23, the “loss at equilibrium point” becomes greater (Δ) in comparison to the first control.

### (Third Control)

In the third control, while maintaining the phase difference ratio d, the low voltage duty dL, and the high voltage duty dH to be equal (d=dL=dH), the phase difference ratio d, the low voltage duty dL, and the high voltage duty dH are changed according to the load. The phase difference ratio d is changed within the following range of

−0.5≦d≦0.5.

It is thereby possible to deal with the “continuous switching between powering and regeneration.” The low voltage duty dL and the high voltage duty dH are changed within the following range of

0≦dL≦0.5

0≦dH≦0.5

in correspondence with the range of (0≦d≦0.5) of change on the positive polarity side of the foregoing phase difference ratio d.

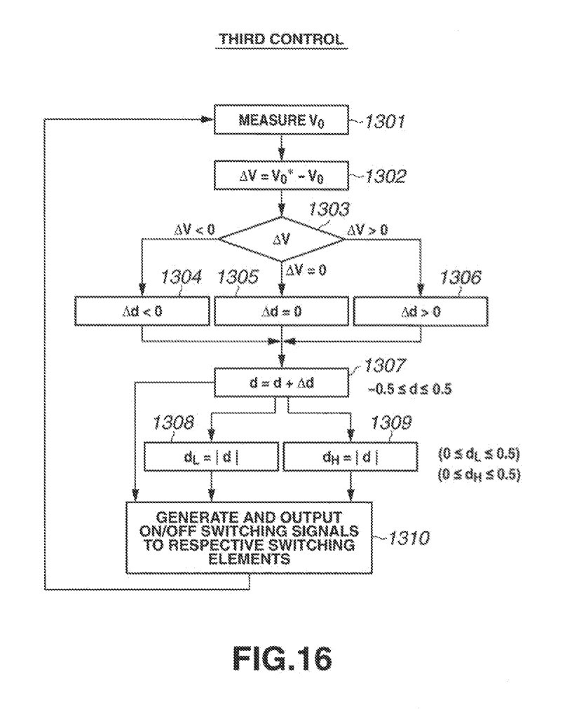

The controller 80 implements the third control according to the flowchart shown in FIG. 16.

In other words, the controller 80 measures the current output voltage V0 (step 1301), feeds back the current output voltage V0 that was measured, and computes the deviation ΔV=V0*−V0 of the output voltage target value V0* (550 V) and the current value (step 1302). Subsequently, according to whether the deviation ΔV is ΔV<0 or ΔV=0 or ΔV>0 (step 1303), the variation Δd of the phase difference ratio d is obtained (steps 1304, 1305, 1306). In other words, when it is ΔV<0, the variation Δd of the phase difference ratio d is set to a predetermined decrement Δd (<0) of a negative polarity (step 1304). When it is ΔV=0,the variation Δd of the phase difference ratio d is not increased or decreased; that is, it is set to Δd=0 (step 1305). When it is ΔV>0, the variation Δd of the phase difference ratio d is set to a predetermined increment Δd(>0) of a positive polarity (step 1306).

Next, the phase difference variation Δd that was obtained in steps 1304, 1305, 1306 is added to the current phase difference ratio d, and the current phase difference ratio d is updated (d←d+Δd). However, the phase difference ratio d is changed within the range of −0.5≦d≦0.5 (step 1307).

Next, the absolute value |d| of the phase difference ratio d that was updated in step 1307 is set to be equivalent to the low voltage duty dL and the high voltage duty dH (dL=|d|, dH=|d|). Consequently, the low voltage duty dL and the high voltage duty dH will change within the range of 0≦dL≦0.5, 0≦dH≦0.5 (steps 1308, 1309).

Next, the controller 80 generates and outputs the switching signals to be applied to the respective switching elements 51 to 58 to achieve the respective values of the phase difference ratio d, the low voltage duty dL, and the high voltage duty dH based on the phase difference ratio d that was updated in step 1307 and the values of the low voltage duty dL and the high voltage duty dH that were obtained in steps 1308, 1309. Consequently, the ON/OFF operation of the respective switching elements 51 to 54 (or 55 to 58) is performed as shown in FIGS. 4B, 4C, 4D, 4E, the ON/OFF operation of the low voltage winding inter-terminal voltage v1 (or high voltage inter-terminal voltage v2) is performed as shown in FIG. 4A, and becomes a powering status or a regeneration status as shown in FIGS. 6A, 6B (step 1310).

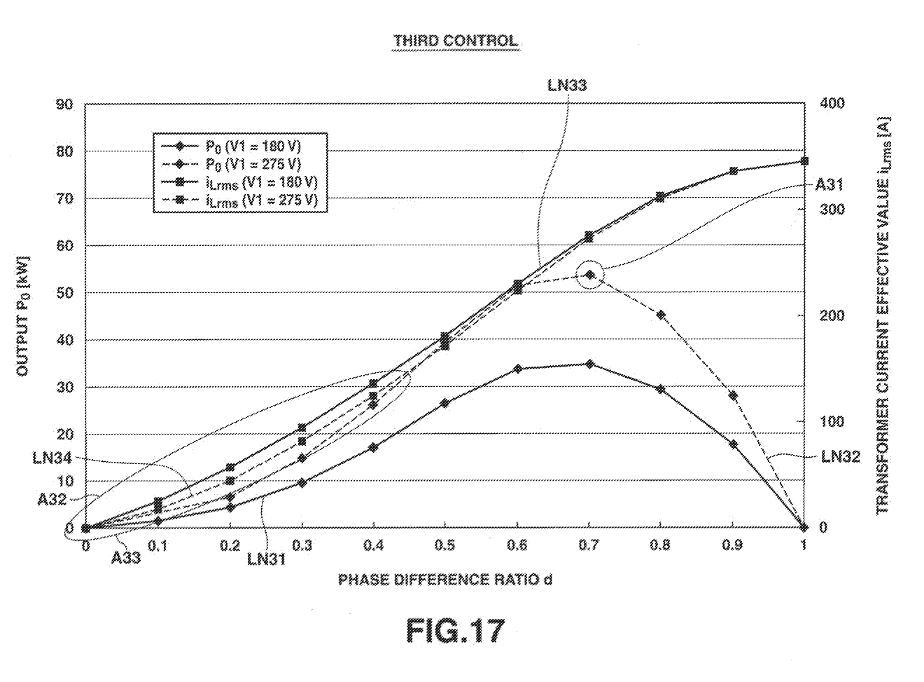

FIG. 17 is a graph explaining the third control. The horizontal axis of FIG. 17 is the phase difference ratio d (=low voltage duty dL=high voltage duty dH), the left vertical axis is the output power P0 (kW), and the right vertical axis is the transformer current effective value iLrms (A). FIG. 17 shows the characteristics LN31 of the output power P0 of a case (voltage conditions at a point away from the equilibrium point) where the input voltage V1 (low-voltage side winding inter-terminal voltage maximum value V1) is 180 V, the characteristics LN32 of the output power P0 of a case (voltage conditions at the equilibrium point) where the input voltage V1 (low-voltage side winding inter-terminal voltage maximum value V1) is 275 V, the characteristics LN33 of the transformer current effective value iLrms of a case (voltage conditions at a point away from the equilibrium point) where the input voltage V1 (low-voltage side winding inter-terminal voltage maximum value V1) is 180 V, and the characteristics LN34 of the transformer current effective value iLrms of a case (voltage conditions at the equilibrium point) where the input voltage V1 (low-voltage side winding inter-terminal voltage maximum value V1) is 275 V.

The comparative results of the third control and the other controls are shown in FIG. 13.

As evident from the comparative results of the respective controls shown in FIG. 13, the “continuous switching between powering and regeneration” can be achieved (◯) by changing the phase difference ratio d, and, although the “output limit” is lower (Δ) in comparison to the first control and the second control as shown in part A31 of FIG. 17, the “loss based on light load at a point away from the equilibrium point” becomes extremely small (⊚) in comparison to the first control and the second control as shown in part A32. Nevertheless, as shown in part A33, the “loss at equilibrium point” becomes greater (Δ) in comparison to the first control.

### (Fourth Control)

In the fourth control, the second control and the third control are combined and simultaneously used.

The second control; that is, the control of fixing the phase difference ratio d to be constant at 0.5, and the third control; that is, the control of maintaining the phase difference ratio d, the low voltage duty dL, and the high voltage duty dH to be equal, will take on the same value when the values of the phase difference ratio d, the low voltage duty dL, and the high voltage duty dH are equal at 0.5. Thus, with the point where the values of the phase difference ratio d, the low voltage duty dL, and the high voltage duty dH become equal at 0.5 as with switching point, the respective parameters described above are continuously changed so as to switch between the second control and the third control.

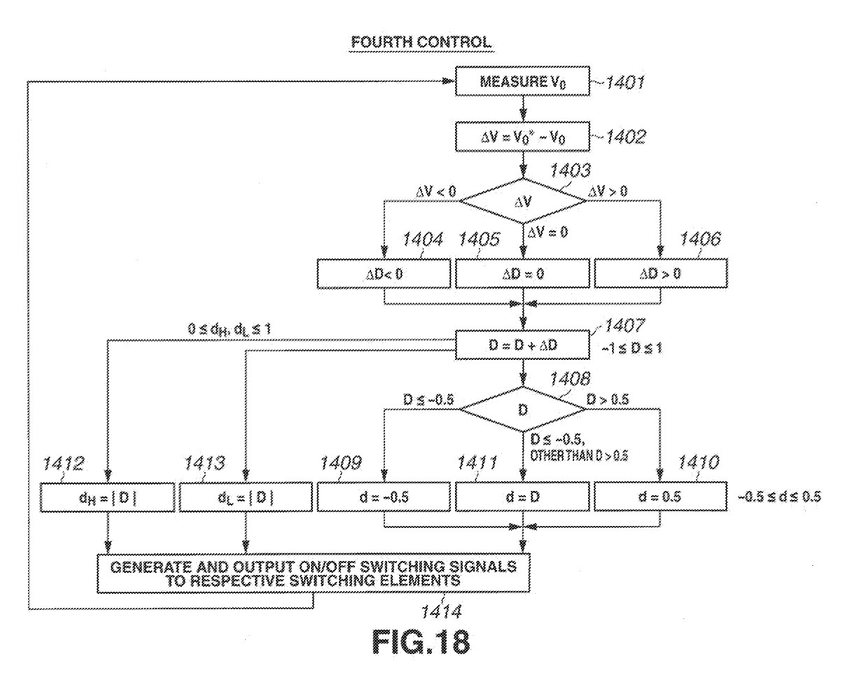

The controller 80 implements the fourth control according to the flowchart shown in FIG. 18. In the ensuing explanation, a variable D, and a variation ΔD as the predetermined increase/decrease thereof are introduced. The variable D is changed within the range of −1≦D≦1.

In other words, the controller 80 measures the current output voltage V0 (step 1401), feeds back the current output voltage V0 that was measured, and computes the deviation ΔV=V0*−V0 of the output voltage target value V0* (550 V) and the current value (step 1402). Subsequently, according to whether the deviation ΔV is ΔV<0 or ΔV=0 or ΔV>0 (step 1403), the variation ΔD of the variable D is obtained (steps 1404, 1405, 1406). In other words, when it is ΔV<0, the variation ΔD of the variable D is set to a predetermined decrement ΔD (<0) of a negative polarity (step 1404). When it is ΔV=0, the variation ΔD of the variable D is not increased or decreased; that is, it is set to ΔD=0 (step 1405). When it is ΔV>0, the variation AD of the variable D is set to a predetermined increment ΔD (>0) of a positive polarity (step 1406).

Next, the variation ΔD of the variable D that was obtained in steps 1404, 1405, 1406 is added to the current variable D, and the current variable D is updated (D←D+ΔD). However, the variable D is changed within the range of −1≦D≦1 (step 1407).

Next, the phase difference ratio d is obtained (steps 1409, 1410, 1411) according to whether the variable D that was updated in step 1407 is D≦−0.5, D>0.5, or other than D≦−0.5 and D>0.5 (step 1408). In other words, when it is D≦−0.5, the phase difference ratio d is set to −0.5 (step 1409). When it is D>0.5, the phase difference ratio d is set to 0.5 (step 1410). When the variable D is a value other than D≦−0.5 and D>0.5, the variable D is set to be equivalent to the phase difference ratio d (d=D). However, the phase difference ratio d is changed within the range of −0.5≦d≦0.5 (step 1411).

Next, the absolute value |D| of the variable D that was updated in step 1407 is set to be equivalent to the high voltage duty dH and the low voltage duty dL (dH=|D|, dL=|D|). Consequently, the high voltage duty dH and the low voltage duty dL will change within the range of 0≦dH≦1, 0≦dL≦1 (steps 1412, 1413).

Next, the controller 80 generates and outputs the switching signals to be applied to the respective switching elements 51 to 58 to achieve the respective values of the phase difference ratio d, the high voltage duty dH, and the low voltage duty dL based on the phase difference ratio d that was obtained in steps 1409, 1410, 1411 and the values of the high voltage duty dH and the low voltage duty dL that were obtained in steps 1412, 1413. Consequently, the ON/OFF operation of the respective switching elements 51 to 54 (or 55 to 58) is performed as shown in FIGS. 4(b), (c), (d), (e), the ON/OFF operation of the low voltage winding inter-terminal voltage v1 (or high voltage inter-terminal voltage v2) is performed as shown in FIG. 4(a), and becomes a powering status or a regeneration status as shown in FIGS. 6(a), (b) (step 1414).

The comparative results of the fourth control and the other controls are shown in FIG. 13.

Since the fourth control is a combination of the second control and the third control, it can obtain the advantages of both the second control and the third control by executing the control shown in FIG. 18.

In other words, the “continuous switching between powering and regeneration” can be achieved (◯) by changing the phase difference ratio d, the “output limit” is equally high (◯) as the first control, and the “loss based on light load at a point away from the equilibrium point” becomes extremely small (⊚) in comparison to the first control and the second control. Nevertheless, the “loss at equilibrium point” becomes greater (Δ) in comparison to the first control.

### (Fifth Control)

In the fifth control, the optimal combination of the phase difference ratio d, the low voltage duty dL, and the high voltage duty dH are set in advance according to the input voltage V1, and the control is performed by reading the settings.

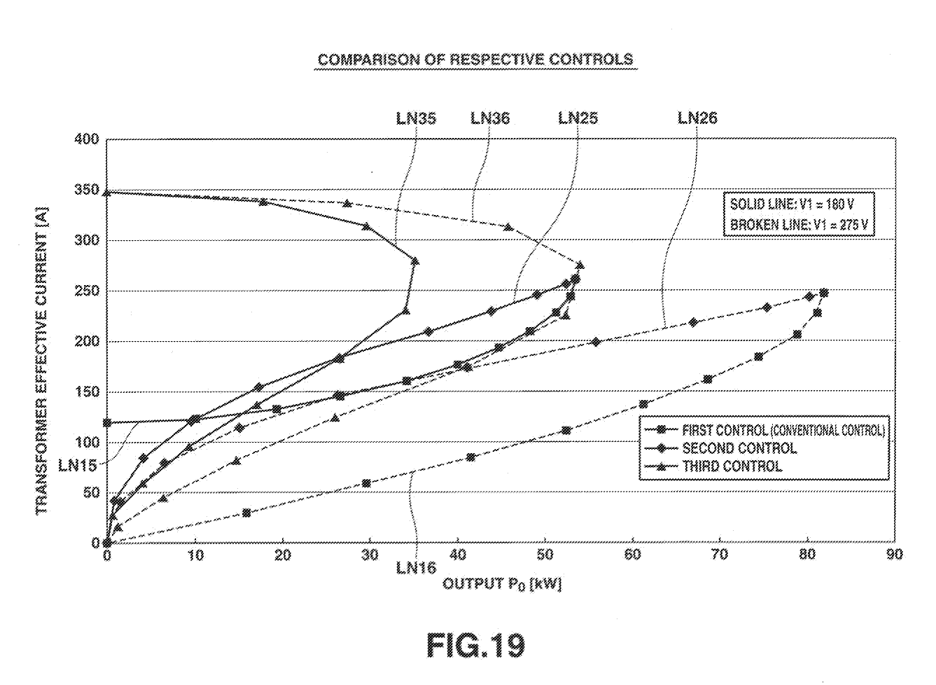

FIG. 19 is a graph for comparing the foregoing first control, second control, and third control.

The horizontal axis of FIG. 19 is the output power P0 (kW), and the vertical axis is the transformer current effective value iLrms (A).

FIG. 19 shows the characteristics of a case (voltage conditions at a point away from the equilibrium point) where the input voltage V1 (low-voltage side winding inter-terminal voltage maximum value V1) is 180 V as LN15, LN25, LN35. LN15 shows the characteristics of the first control, LN25 shows the characteristics of the second control, and LN35 shows the characteristics of the third control.

Moreover, FIG. 19 shows the characteristics of a case (voltage conditions at the equilibrium point) where the input voltage V1 (low-voltage side winding inter-terminal voltage maximum value V1) is 275 V as LN16, LN26, LN36. LN16 shows the characteristics of the first control, LN26 shows the characteristics of the second control, and LN36 shows the characteristics of the third control.

Upon reviewing FIG. 19, it is possible to compare the size of the transformer current effective values iLrms relative to the same output power P0. Since the transformer current effective value iLrms represents the current flowing inside the circuit of the transformer coupling type booster 50, the loss will be smaller as the transformer current effective value iLrms relative to the same output power P0 decreases.

Note that, with the fourth control, the characteristics are such that the characteristics LN25 of the second control and the characteristics LN35 of the third control are switched in the voltage conditions at a point away from the equilibrium, and the characteristics are such that the characteristics LN26 of the second control and the characteristics LN36 of the third control are switched in the voltage conditions at the equilibrium point.

The comparative results of the first control, the second control, the third control, and the fourth control are shown in FIG. 13.

The “continuous switching between powering and regeneration” can be achieved (◯) in the first control, the third control and the fourth control since the phase difference ratio d is changed. Nevertheless, the “continuous switching between powering and regeneration” cannot be achieved (X) in the second control since the phase difference ratio d is fixed.

As shown in part A41 and part A42 of FIG. 19, the “output limit” is high (◯) in the first control, the second control and the fourth control, but the “output limit” is low (Δ) in the third control.

As shown in part A43 and part A44 of FIG. 19, the “loss based on light load at a point away from the equilibrium point” decreases in the order of first control (Δ), second control (◯), third control and fourth control (⊚). Meanwhile, as shown in part A45 and part A46 of FIG. 19, the “loss at equilibrium point” is small in the first control (⊚) in comparison to the second control (Δ), the third control (Δ), and the fourth control (Δ).

In light of the above, it is desirable to perform the third control during a low load and to perform the first control during a high load. However, the timing of switching between the foregoing controls will change depending on the voltage conditions. Thus, the input voltage V1 was changed variously to seek the ideal characteristics of the fifth control.

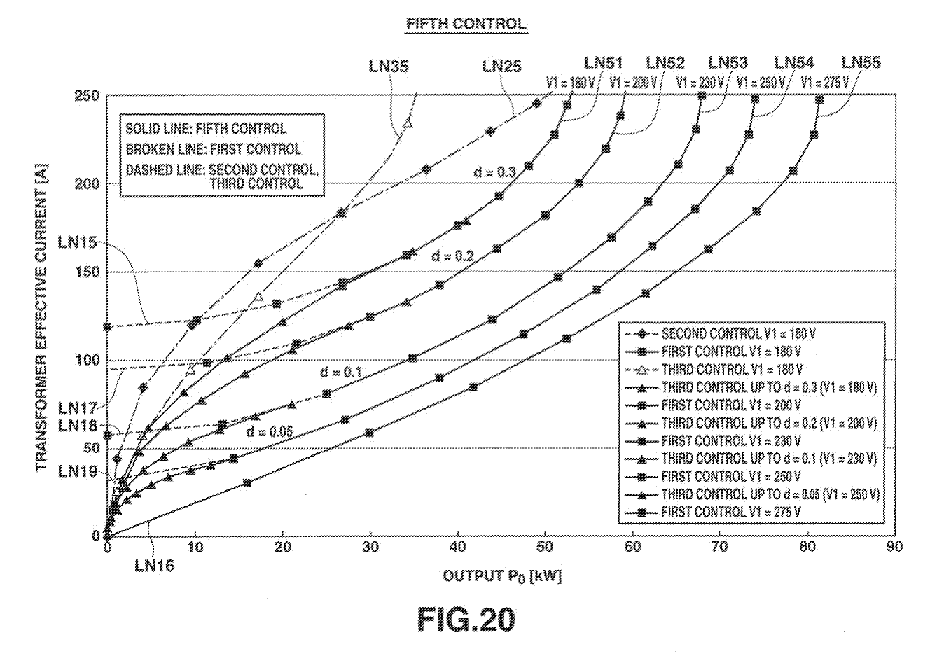

FIG. 20 shows the characteristics of the fifth control where, as with FIG. 19, the horizontal axis shows the output power P0 (kW) and the vertical axis shows the transformer current effective value iLrms (A).

FIG. 20 shows the characteristics LN51, LN52, LN53, LN54, LN55 of the fifth control, respectively with solid lines, in cases of the changing the input voltage V1 (low-voltage side winding inter-terminal voltage maximum value V1) to 180 V, 200 V, 230 V, 250 V, 275 V (equilibrium point).

Moreover, by way of comparison, FIG. 20 also shows the characteristics LN15, LN17, LN18, LN19, LN16 of the first control, respectively with broken lines, in cases of changing the input voltage V1 (low-voltage side winding inter-terminal voltage maximum value V1) to 180 V, 200 V, 230 V, 250 V, 275 V (equilibrium point). Moreover, by way of comparison, the characteristics LN25 of the second control and the characteristics LN35 of the third control in cases where the input voltage V1 (low-voltage side winding inter-terminal voltage maximum value V1) is 180 V are shown with dashed lines.

As shown in FIG. 20, the third control is switched to the first control at a point where the load is great and at a point where the output power P0 is great as they are separated from the equilibrium point. In other words, when the input voltage V1 (low-voltage side winding inter-terminal voltage maximum value V1) is 180 V, the characteristics of the third control are switched to the first control LN15 (characteristics LN51 of the fifth control) when the phase difference ratio d becomes 0.3.

Moreover, when the input voltage V1 (low-voltage side winding inter-terminal voltage maximum value V1) is 200 V, the characteristics of the third control are switched to the first control LN17 (characteristics LN52 of the fifth control) when the phase difference ratio d becomes 0.2.

Furthermore, when the input voltage V1 (low-voltage side winding inter-terminal voltage maximum value V1) is 230 V, the characteristics of the third control are switched to the first control LN18 (characteristics LN53 of the fifth control) when the phase difference ratio d becomes 0.1.

Moreover, when the input voltage V1 (low-voltage side winding inter-terminal voltage maximum value V1) is 250 V, the characteristics of the third control are switched to the first control LN19 (characteristics LN54 of the fifth control) when the phase difference ratio d becomes 0.05.

Furthermore, when the input voltage V1 (low-voltage side winding inter-terminal voltage maximum value V1) is 275 V (equilibrium point), the first control LN16 is switched to the characteristics of the fifth control (characteristics LN55 of the fifth control).

Thus, optimal values of the phase difference ratio d, the low voltage duty dL, and the high voltage duty dH are set in advance, in correspondence with the input voltage V1, according to the foregoing characteristics LN51 to LN55 of the fifth control.

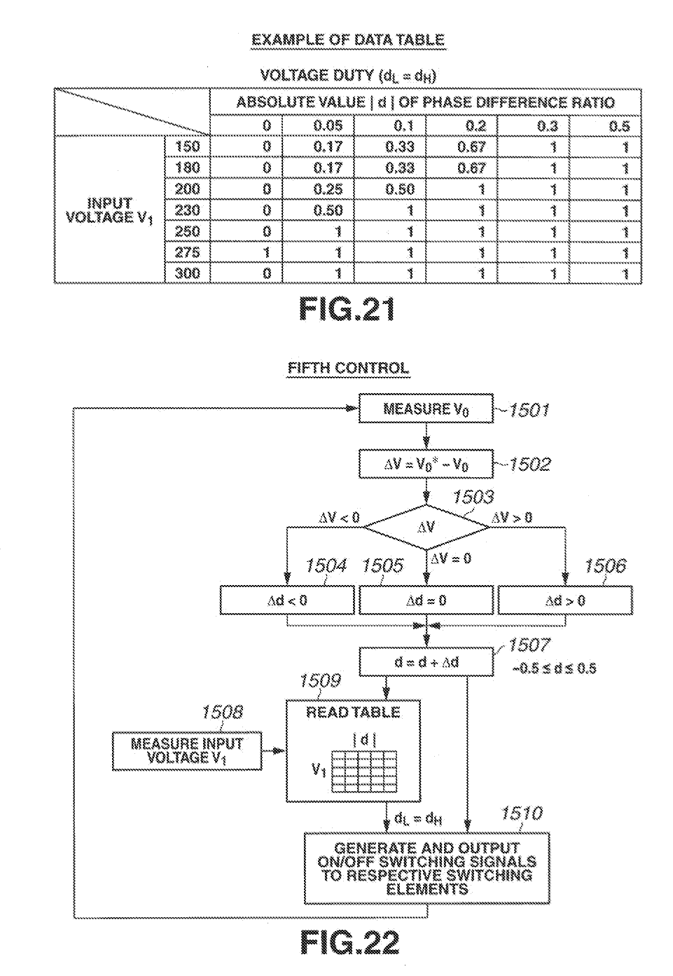

Specifically, as shown in FIG. 21, the optimal value of the low voltage duty dL (=high voltage duty dH) is stored in a predetermined memory within the controller 80 in a data table format in correspondence with the respective values (150 V, 180 V, 200 V, 230 V, 250 V, 275 V, 300 V) of the input voltage V1, and the respective values (0.05, 0.1, 0.2, 0.3, 0.5) of the absolute value |d| of the phase difference ratio d.

The controller 80 implements the fifth control according to the flowchart shown in FIG. 22.

In other words, the controller 80 measures the current output voltage V0 (step 1501), feeds back the current output voltage V0 that was measured, and computes the deviation ΔV=V0*−V0 of the output voltage target value V0* (550 V) and the current value (step 1502). Subsequently, according to whether the deviation ΔV is ΔV<0 or ΔV=0 or ΔV>0 (step 1503), the variation Δd of the phase difference ratio d is determined (steps 1504, 1505, 1506). In other words, when it is ΔV<0, the variation Δd of the phase difference ratio d is set to a predetermined decrement Δd(<0) of a negative polarity (step 1504). When it is ΔV=0, the variation Δd of the phase difference ratio d is not increased or decreased; that is, it is set to Δd=0 (step 1505). When it is ΔV>0, the variation Δd of the phase difference ratio d is set to a predetermined increment Δd(>0) of a positive polarity (step 1506).

Next, the phase difference variation Δd that was obtained in steps 1504, 1505, 1506 is added to the current phase difference ratio d, and the current phase difference ratio d is updated (d←d+Δd). However, the phase difference ratio d is changed within the range of −0.5≦d≦0.5 (step 1507).

Next, the controller 80 measures the current input voltage V1 (step 1508), and reads, from the data table shown in FIG. 21, the low voltage duty dL and the high voltage duty dH corresponding to the measured current input voltage V1 and the absolute value |d| of the phase difference ratio d that was updated in step 1507 (step 1509). Next, the controller 80 generates and outputs the switching signals to be applied to the respective switching elements 51 to 58 to achieve the respective values of the phase difference ratio d, the low voltage duty dL, and the high voltage duty dH based on the values of the low voltage duty dL and the high voltage duty dH that were read and the phase difference ratio d that was updated in step 1507. Consequently, the ON/OFF operation of the respective switching elements 51 to 54 (or 55 to 58) is performed as shown in FIGS. 4B, 4C, 4D, 4E, the ON/OFF operation of the low voltage winding inter-terminal voltage v1 (or high voltage inter-terminal voltage v2) is performed as shown in FIG. 4A, and becomes a powering status or a regeneration status as shown in FIGS. 6A, 6B (step 1510).

Since the fifth control is the optimal control combining the first control and the third control, it can obtain the advantages of both the first control and the third control by executing the control shown in FIG. 22.

In other words, the “continuous switching between powering and regeneration” can be achieved (◯) by changing the phase difference ratio d, “output limit” is equally high (◯) as the first control, and the “loss based on light load at a point away from the equilibrium point” becomes extremely small (⊚) in comparison to the first control and the second control. In addition, the “loss at equilibrium point” becomes extremely small (⊚) as with the first control.

Note that the parameters of phase difference ratio d, low voltage duty dL, and high voltage duty dH are defined and these parameters are adjusted, but parameters other than the phase difference ratio d can be used so as long as it is a parameter that can adjust the phase difference δ. Moreover, parameters other than the low voltage duty dL can be used so as long as it is a parameter that can adjust the period (T−TL) where the inter-terminal voltage v1 of the low-voltage side winding 50d becomes zero, and parameters other than the high voltage duty dH can be used so as long as it is a parameter that can adjust the period (T−TL) where the inter-terminal voltage v2 of the high-voltage side winding 50e becomes zero.

### INDUSTRIAL APPLICABILITY

This embodiment was explained on the assumption that the transformer coupling type booster 50 will be mounted on the hybrid construction machine 1. Nevertheless, as this invention, the transformer coupling type booster 50 can also be mounted on an arbitrary transportation machine or an arbitrary industrial machine without limitation to a construction machine. Moreover, if an electrical storage device capable of charging and discharging bulk power is developed in the future in substitute for a capacitor, this invention can also be implemented by being applied to such an electrical storage device.

1. A control device of a transformer coupling type booster in which a low-voltage side inverter and a high-voltage side inverter are coupled via a transformer, and which boosts an input voltage between input terminals of an electrical storage device and applies this as an output voltage between output terminals,
wherein the low-voltage side inverter is configured by including:
four switching elements which are bridge-connected to both terminals of a low-voltage side winding of the transformer; and
a diode connected parallel to each of the switching elements so that its polarity is inverted from that of the switching element,
the high-voltage side inverter is configured by including:
four switching elements which are bridge-connected to both terminals of a high-voltage side winding of the transformer; and
a diode connected parallel to each of the switching elements so that its polarity is inverted from that of the switching element,
both of the inverters are connected in series so that a positive electrode of the low-voltage side inverter and a negative electrode of the high-voltage side inverter have an additive polarity,
the control device comprises control means for performing switching control of applying ON/OFF switching signals to the respective switching elements and alternately repeating, at a predetermined cycle, a voltage positive polarity period where an inter-terminal voltage of the low-voltage side winding and an inter-terminal voltage of the high-voltage side winding have a positive polarity, and a voltage negative polarity period where those inter-terminal voltages have a negative polarity, and
the control means adds, upon performing the switching control, control of providing a zero voltage period between the voltage positive polarity period and the voltage negative polarity period of the inter-terminal voltage of the low-voltage side winding or/and the inter-terminal voltage of the high-voltage side winding.

2. The control device of a transformer coupling type booster according to claim 1,
wherein the control means forms the zero voltage period between the voltage positive polarity period and the voltage negative polarity period of the inter-terminal voltage of the low-voltage side winding or/and the inter-terminal voltage of the high-voltage side winding by providing a phase difference between the respective switching signals to be applied to the respective switching elements configuring the low-voltage side inverter or/and providing a phase difference between the respective switching signals to be applied to the respective switching elements configuring the high-voltage side inverter.

3. The control device of a transformer coupling type booster according to claim 1,
wherein the control means adjusts, as parameters, a phase difference between the respective switching signals to be applied to the respective switching elements configuring the low-voltage side inverter and the respective switching signals to be applied to the respective switching elements configuring the high-voltage side inverter, a period where the voltage becomes zero between the terminals of the low-voltage side winding, and a period where the voltage becomes zero between the terminals of the high-voltage side winding.

4. The control device of a transformer coupling type booster according to claim 3,
wherein optimal parameter values are set in advance in correspondence with operating conditions including the input voltage between the input terminals of the electrical storage device and the output voltage of the transformer coupling type booster and a transformer turns ratio.
